(19) United States
(12) Patent Application Publication
(10) Pub. No.: US 2004/0254007 A1
(43) Pub. Date: Dec. 16, 2004

(54) Lottery scan tag or card

(76) Inventor: Cheryl C. Reep, Pembroke Pines, FL (US)

Correspondence Address: CHERYL C. REEP, 310 NW 207TH WAY, PEMBROKE PINES, FL, 33029, US

(21) Appl. No.: 10/832,406

(22) Filed: Apr. 27, 2004

Related U.S. Application Data
(60) Provisional application No. 60/477,816, filed on Jun. 12, 2003.

(51) Int. Cl. G06F 17/00; G06F 19/00

(52) U.S. Cl. 463/17

(57) ABSTRACT

This invention is to be used in conjunction with a lottery system. It can be simply described as a “scan tag” to be placed on a key chain or “scan card”. The tag or card would have a bar code, metallic strip or other encryption to be scanned by a reading device. The encrypted bar code or strip would contain a series of playing numbers; or one serial number (or code of any type) linked to playing numbers and/or player information to be read by said device. Once scanned, a valid lottery ticket (s) will be printed. The ticket (s) will contain a set (s) of numbers assigned to the scan tag or card by the lottery player in conjunction with the lottery agency. A player's personal information (name, address, phone) may also be included in the encryption on the scan tag/card for tracking purposes, but only as an option.

### RELATED APPLICATION

This application hereby claims priority under 35 U.S.C. § 119 to U.S. Provisional patent application Ser. No. 60/477,816, filed Jun. 12, 2003.

### BACKGROUND OF THE INVENTION

1. Field of the Invention

The invention relates primarily to a device for, and method of, purchasing lottery tickets. More specifically, the present invention is directed to a reusable lottery device and method for entering a player's pre-selected wager information (lottery playing numbers), which is/are linked to a serial number or encrypted code via internet, telephone or mail into a lottery system. The invention works in conjunction with a scanning device or optical reader, which gleans the information from the invention, processes it, and prints out a valid lottery ticket.

2. Description of the Related Art

Lotteries are well known in the art. A lottery is a game where players purchase one or more tickets, each containing the player's selected numbers, in exchange for a ticket price, Uniform among all players in a particular game. The quantity of correct numbers necessary to win varies amongst various lottery games. At least a portion of the money given by each player for the purchase of the ticket is placed into a “pot”. The “pot” is the prize that the winning player or players will receive. Most often, the “pot” is over a million dollars, and is frequently in the range of several hundreds of millions of dollars. Tickets for a particular game may be purchased up until a specific time. Once the time for purchasing tickets has passed, the lottery administrators, who are entrusted with administering the game fairly, select the winning numbers for that particular game. There are several prior art patents, which have similar themes of issuing cards to lottery players. For example, lottery systems based on the use of cards are disclosed in U.S. Pat. Nos. 4,764,666 (Bergeron), U.S. Pat. No. 4,882,473 (Bergeron et al.), and U.S. Pat. No. 5,223,698 (Kapur). The Bergeron and Kapur patents involve storing actual wager information on the cards however, rather than simply linking wager information stored within a central lottery computer system to a pre-existing number on a scan tag, or card.

The lottery, as it exists now, involves several steps for players to participate. As an example, assume a particular lottery game requires 6 numbers to win and a player, Player, wishes to play the numbers 1, 2, 3, 4, 5, and 6. Player would go to a lottery entry location, communicate his or her selected numbers, pay the ticket fee, generally $1, and receive a ticket receipt indicating that numbers 1, 2, 3, 4, 5, and 6 have been chosen by the player. A plurality of other players will follow a similar process. At a time subsequent to the deadline to purchase tickets, numbers will be selected by the lottery administrators. If a single player successfully chose the winning numbers, he wins the pot. If several players selected the correct numbers, those players will share the pot (prize).

Currently, there are two methods of choosing numbers when purchasing a lottery ticket. The first option is “bubbling in” a group of numbers on a piece of paper with a pencil. That piece of paper is then fed through an optical device that reads the penciled-in circles and prints out a lottery ticket indicating which numbers were selected. The second method is allowing the computer to automatically select a group of numbers and print out a valid ticket. This method is commonly known as a “quick pick.”

There are several problems with the above-mentioned prior-art methods of selecting lottery numbers. The majority of lottery games have 100 numbers to choose from, which necessitates filling 100 bubbles and their corresponding numbers onto a single small sheet. In the first method, not only is pencilling in small bubbles a time consuming and tedious task, accuracy is also a problem.

In the second method, the numbers are randomly selected by the computer, resulting in a time savings by the player, but has the disadvantage that the player cannot chose his or her own selected numbers.

There is therefore a need in the lottery industry to provide a more convenient way for players to play regular numbers without having to “bubble-in” a piece of paper, or sacrifice playing their regularly-played numbers in order to save time.

### SUMMARY OF THE INVENTION

It is accordingly an object of the invention to provide a device and method of entering a player's chosen numbers into a lottery game that overcomes the hereinabove-mentioned disadvantages of the heretofore-known devices and methods of this general type.

The invention virtually eliminates the “bubble-in” system currently in place and provides a quick, convenient way for lottery players to play regular numbers.

The invention has at least two embodiments and provides players with a key chain tag or card to facilitate processing and printing a player's selected lottery numbers. The card or tag would contain an individual serial number via bar code, magnetic strip or any other encryption method. In a first scenario, the player's playing numbers (wager information) would be electronically linked to a serial number recorded with the lottery agency. The player, via phone, mail, or Internet, would transmit the information to the agency in advance of using it. In a second instance, the encryption on the scan tag would not only contain one or more sets of numbers the user desires to play regularly in the lottery, and may or may not include the player's personal information such as name, address, and phone number.

In one preferred embodiment, a lottery player will present the scan tag to a lottery retailer. The lottery retail agent will then pass an electronic reading device over the scan tag. Alternatively, the scan tag can also be passed over an electronic reader. The user will then pay for the amount of tickets desired. The reader will then process the information gleaned from the scan tag and communicate with the lottery agency via the communications port and finally print the valid lottery ticket(s). As an option, but not required, the player's personal information could be automatically stored and/or transmitted to the lottery agency.

In another embodiment, the invention is a credit-card type design that can be stored in a wallet. In another embodiment, the invention can be any other object capable of storing machine-readable information so that the information can be communicated to a lottery entry device.

An example of this invention's use is as follows: A player desires that the numbers 5, 14, 21, 36, 43, and 49 be played in a lottery twice a week. He will fill out an information card provided by the lottery agency. He will include his name, address, phone number, payment information if so desired, and the aforementioned six numbers. He will then mail the information card to the lottery agency. In return, the lottery agency will mail him back this invention—a scan tag or card with a bar code and serial number linked to the information he previously submitted. This lottery player can now conveniently play his desired numbers without having to bubble in paper.

There is also the possibility that a retailer may be able to give the user a scan tag immediately on demand with an individually encrypted serial number already on it. The user would then have to provide his/her desired playing numbers to the lottery agency which would, in turn, electronically link the numbers and the player's personal information to the serial number on the scan tag or card. The linking of personal information is merely an option but not required for the invention. The desired playing numbers (wager information) and/or personal information could be communicated via phone, mail or the Internet to the lottery agency. In other words, upon receiving the scan tag or card, the player would, for example, log onto the lottery agency's internet website, enter the serial number from the scan tag and then enter wager information to be linked to that scan tag or card. Personal information may also be entered at that time and a password for protection purposes.

With the foregoing and other objects in view, there is provided, in accordance with the invention, a device for storing a player's chosen numbers and entering the numbers into a lottery system, comprising a non-pliable medium, having a plurality of machine-readable player-selected lottery numbers encoded in a dedicated area, wherein the plurality of numbers can be interpreted by a lottery-entry device and submitted to a lottery system as a player's selected numbers for a particular game.

In particular, it is an object of the invention to provide the above-mentioned device for use in combination with a lottery entry machine, wherein the lottery entry machine has a port for reading the encoded numbers, a processor for decoding the encoded numbers, and a communications port for communicating the numbers to a main lottery system or agency.

With the foregoing and other objects in view, there is provided, in one embodiment in accordance with the invention, a card or tag where the encrypted area contains a pre-existing serial number, or code, which may later be assigned to a set of playing numbers and/or a player via phone, mail or Internet.

It is also an object of the invention to provide a scan tag that is portable, durable, and easily read by a lottery entry device.

In accordance with an added feature of the invention, the non-pliable medium is made of a plastic or synthetic material.

In accordance with an additional feature of the invention, the non-pliable medium is comprised of a metal material.

In accordance with yet another feature of the invention, the dedicated area is an area of magnetic material.

In accordance with yet a further feature of the invention, the dedicated area has a series of lines of varying distances and/or thickness.

In accordance with yet an added feature of the invention, the non-pliable medium can includes artwork, text, logos, holiday graphics, seasonal graphics, special occasion graphics, and festive graphics as well as other designs.

In accordance with yet another added feature of the invention, the non-pliable medium is constructed of materials of various size, composition, texture, and thickness.

In accordance with yet an additional feature of the invention, the communications port is a phone line.

In accordance with again another feature of the invention, the communications port is a Dedicated Subscriber Line.

In accordance with again a further feature of the invention, the port for reading the encoded numbers is an optical reader.

In accordance with still a further feature of the invention, the port for reading the encoded numbers is a magnetic stripe reader.

In accordance with yet another feature of the invention, the port for reading the encoded numbers is a bar code scanner.

Other features that are considered as characteristic for the invention are set forth in the appended claims.

Although the invention is illustrated and described herein as embodied in an apparatus for storing a player's selected lottery numbers, it is nevertheless not intended to be limited to the details shown, since various modifications and structural changes may be made therein without departing from the spirit of the invention and within the scope and range of equivalents of the claims.

This invention may also be used when playing lottery games that require 3, 4, or more correct numbers to win.

The construction of the invention, however, together with additional objects and advantages thereof will be best understood from the following description of the specific embodiment when read in connection with the accompanying drawings.

### BRIEF DESCRIPTION OF THE DRAWINGS

Further objects and advantages of the present inventions can be found in the description of the preferred embodiments when taken in conjunction with the accompanying drawings in which:

FIG. 1 is a prior-art lottery entry form

FIG. 2 is a top view of the scan tag;

FIG. 3 is a bottom view of the scan tag;

FIG. 4 is a top view of the scan card;

FIG. 5 is a bottom view of the scan card; and

FIG. 6 is a lottery entry device connected to a lottery system.

FIG. 7 is an optical reader attached via a line to the lottery entry device connected to a lottery system.

### DESCRIPTION OF THE PREFERRED EMBODIMENTS

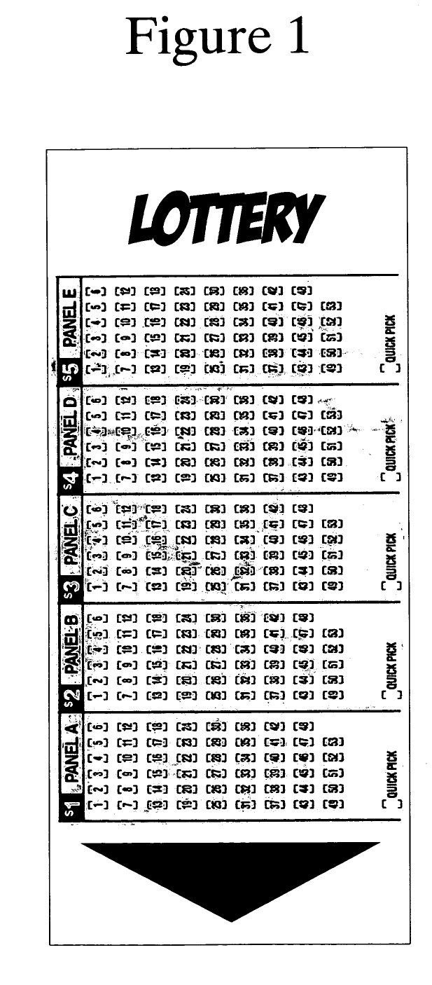

Referring now to the figures of the drawings in detail, and in particular to FIG. 1, there is illustrated and example of existing lottery technology. The sheet of paper 100 is “bubbled in” by a player and then fed into a terminal, which reads the penciled in numbered squares 101 and prints lottery tickets. On the top is the lottery graphic 102. The card is divided into panels 103 allowing for up to five sets of numbers to be played. There is also the option of choosing a “quick pick” 104. In this case, the machine would randomly pick a set of numbers and automatically print the ticket(s). The arrow 105 shows the direction the ticket needs to be fed into the machine to ensure proper operation.

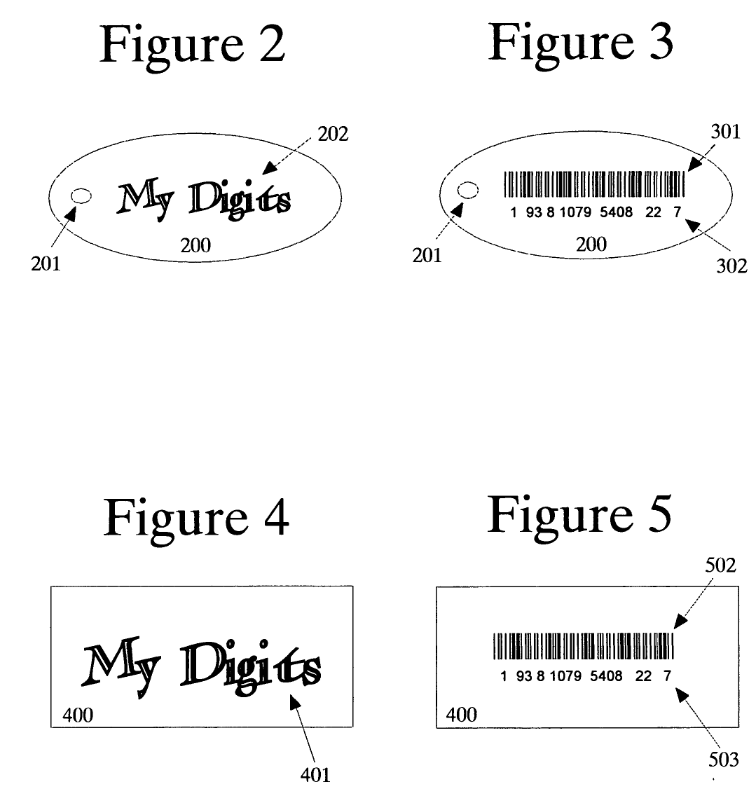

FIG. 2 shows the scan tag (frontal view) 200. There is also a hole 201 for easy attachment to a key chain. In the center is a logo 202, generic. Any kind of graphic, text, and/or artwork may be placed at 202.

FIG. 3 shows a rear view of the scan tag 200. Visible is the hole 201 for key chain attachment. Also illustrated is the bar code 301, and serial number 302, which are linked to the player's wager and/or personal information. 301 is machine-readable.

FIG. 4 shows the frontal view of the scan card 400, which is almost the same concept as the scan tag, minus the hole for key chain attachment. Illustrated is the text, graphics, and artwork 401.

FIG. 5 shows the rear of the scan card 400. The bar code 502, and serial number 503 are linked to the user's wager and/or personal information.

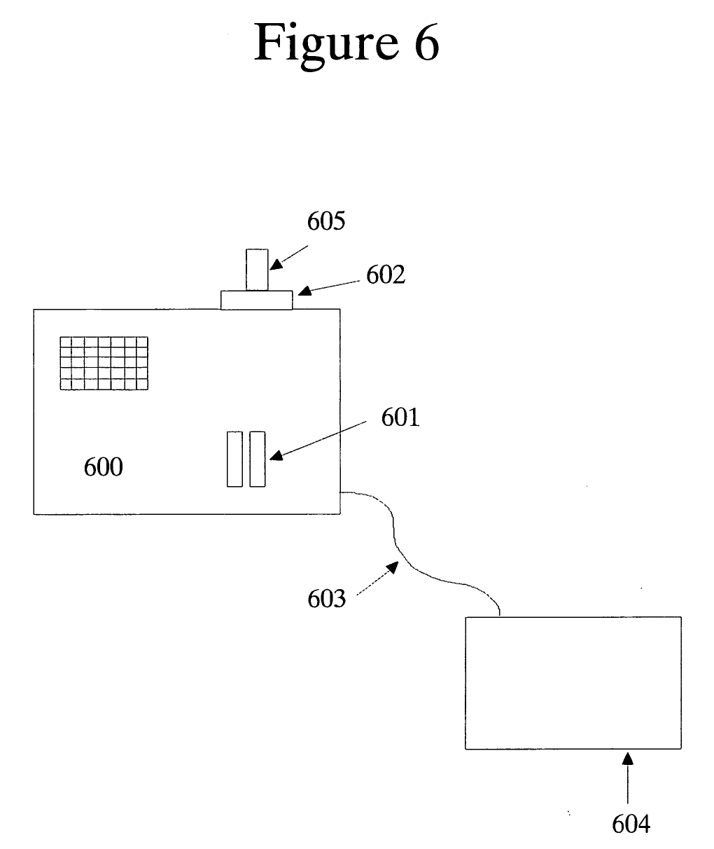

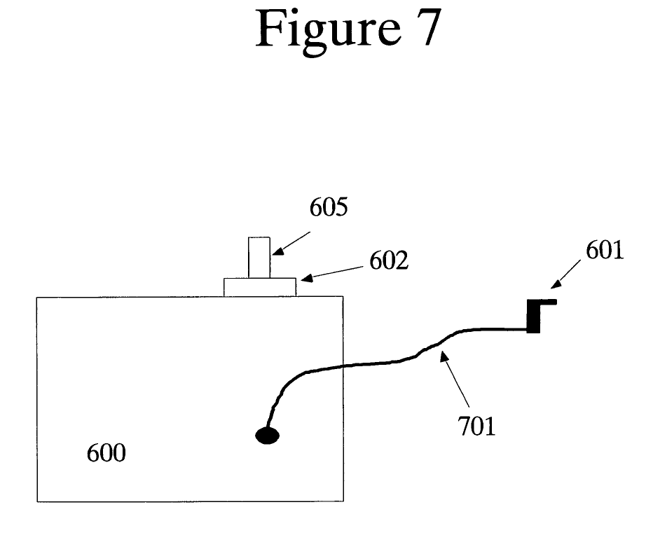

FIG. 6 shows lottery entry device 600 connected via communication port 603 to the lottery entry station 604. Lottery entry device 600 is equipped with a reader 601. The reader 601 can be a magnetic stripe reader, an optical reader, or any other similar reader, that can interpret information stored on a scan tag 200 or scan card 400 or decipher serial number information and link it to wager and/or other information stored in a database. These types of readers are common and known to those of ordinary skill in the art. In addition, as shown in FIG. 7, the reader 601 can be attached to the lottery entry device 600 via a line 701. In this configuration, the reader 601 can be used to read a scan tag 200 or scan card 400 away from the lottery entry device 600, as least as far as the line 701. Referring back to FIG. 6, the lottery entry device is preferably equipped with a printer 602 to print a lottery ticket 605, which acts as a receipt for the entry of the player's numbers.

I claim:

1. A device for storing a player's chosen numbers and method of entering the numbers into a lottery system, comprising:
a non-pliable medium having a plurality of machine-readable player-selected lottery numbers encoded in a dedicated area, wherein said plurality of numbers can be interpreted by a lottery-entry device and submitted to a lottery system as a player's selected numbers for a particular game.

2. The device according to claim 1, wherein the encrypted area contains a pre-existing serial number, or code, which may later be assigned by the player to a set of playing numbers or wager information via phone, mail or Internet.

3. The device according to claim 1, wherein said non-pliable medium is comprised of a plastic or synthetic material.

4. The device according to claim 1, wherein said non-pliable medium is comprised of a metal material.

5. The device according to claim 1, wherein said dedicated area is an area of magnetic material.

6. The device according to claim 1, wherein said dedicated area has a series of lines of varying distances and/or thickness.

7. The device according to claim 1, wherein said non-pliable medium includes one or more of artwork, text, logos, holiday graphics, seasonal graphics, special occasion graphics, and festive graphics.

8. The device according to claim 1, wherein said non-pliable medium is constructed of materials of various size, composition, texture, and thickness.

9. A device for use in combination with a lottery entry machine, wherein:
said device comprises a non-pliable medium having a plurality of machine-readable player-selected lottery numbers encoded in a dedicated area; or is linked to a specific serial number or encryption code and
said lottery entry machine comprises a port for reading said encoded numbers, a processor for decoding said encoded numbers, a communications port for communicating said numbers to a main lottery system, and a printer to print a valid lottery ticket.

10. The device according to claim 9, wherein said non-pliable medium is comprised of a plastic or synthetic material.

11. The device according to claim 9, wherein said non-pliable medium is comprised of a metallic material.

12. The device according to claim 9, wherein said dedicated area is an area of magnetic material.

13. The device according to claim 9, wherein said dedicated area has a series of lines of varying distances and/or thickness.

14. The device according to claim 9, wherein said non-pliable medium includes one or more of artwork, text, logos, holiday graphics, seasonal graphics, special occasion graphics, and festive graphics.

15. The device according to claim 9, wherein said non-pliable medium is constructed of materials of various size, composition, texture, and thickness.

16. The lottery entry machine according to claim 9, wherein said communications port is a phone line.

17. The lottery entry machine according to claim 9, wherein said communications port is a Dedicated Subscriber Line.

18. The lottery entry machine according to claim 9, wherein said port for reading said encoded numbers is an optical reader.

19. The lottery entry machine according to claim 9, wherein said port for reading said encoded numbers is a magnetic stripe reader.

20. The lottery entry machine according to claim 9, wherein said port for reading said encoded numbers is a bar code scanner.
